(19) United States
(12) Patent Application Publication
(10) Pub. No.: US 2014/0116566 A1
(43) Pub. Date: May 1, 2014

(54) PIPE LINER AND METHOD OF RELINING A SEWER PIPE

(71) Applicants: Herbert BADER, Nordwalde (DE); Alexander Obneiser, Altenberge (DE); Ralf Niepelt, Gronau (DE)

(72) Inventors: Herbert BADER, Nordwalde (DE); Alexander Obneiser, Altenberge (DE); Ralf Niepelt, Gronau (DE)

(21) Appl. No.: 14/061,889

(22) Filed: Oct. 24, 2013

(30) Foreign Application Priority Data
Oct. 26, 2012 (DE) 102012110265.1
Oct. 29, 2012 (EP) 12190406.4

(51) Int. Cl. F16L 9/12

(52) U.S. Cl. CPC F16L 9/123
USPC 138/140

(57) ABSTRACT

A pipe liner has a tubular base of a thermoplastic elastomer or ionomer saturated with a curable resin, and a tubular inner film inside the tubular base itself. The inner film is formed by a core layer of a thermoplastic elastomer or ionomer and two polyamide outer layers.

### FIELD OF THE INVENTION

The present invention relates to a lining for a pipe. More particularly this invention concerns a method of relining a waste-water or sewer pipe.

### BACKGROUND OF THE INVENTION

It is known to reline a pipe serving as a sewer line with a tubular textile or fiber layer impregnated with a curable resin, and having an inner film within the tubular textile or fiber layer and itself having a polyamide-based layer as a barrier.

Sewer systems are typically part of an inhomogeneous infrastructure that has been added to over years or decades and that is subject to considerable reoccurring stresses. Leaks in the system of sewer lines can result in enormous damage to the environment when liquid sewage seeps from the sewer system into the surrounding soil. Aside from local contamination, leaching can also compromise any surrounding bodies of water or the groundwater. Sewer networks traverse considerable distances and have many branches, thus making their maintenance a very complex undertaking, which is one is always seeking rehabilitation methods that offer the utmost in terms of ease of application. This relates, in particular, also to individual residential sewer connections, where direct access to pipes is not possible at these locations due to the pipe diameters.

Instead of completely replacing entire sections of sewer pipe or conduit, which requires comprehensive earth-moving work, the prior art describes various rehabilitation methods that do not require extensive digging. One such rehabilitation without significant digging provides for the use of a pipe lining material that is usually provided in form of a hose. Corresponding methods are also referred to as relining or hose relining methods. Relining methods of this kind are known in the art in various variants.

Correspondingly, DE 1 912 478 A, U.S. Pat. No. 4,368,091, U.S. Pat. No. 4,865,673, U.S. Pat. No. 6,170,531, and U.S. Pat. No. 6,416,692 describe methods that provide for securing a tubular pipe liner at one end of a sewer pipe, and then inverting the tube by means of a fluid into the sewer pipe to be relined. The inside of the tubular material carries an adhesive that bonds the inverted tube to the inner surface of the line. An inversion-based principle of this kind is, on the whole, comparatively complex and can only be implemented over a limited length of the sewer pipe to be relined. The even incorporation of the adhesive poses another challenge of considerable complexity.

Aside from these inversion processes, other known methods provide for the pipe lining material to be first pulled into the sewer pipe to be relined and subsequently radially expanded by a fluid that presses the coating against the inner surface of a sewer pipe. The pipe liner includes a tubular textile or fiber layer that is impregnated with a curable resin. After the pipe liner has been expanded, the resin is cured by a suitable means in order to fix the pipe liner in the desired position. However, often there is the problem that the curable resin contains styrene, which must not be released into the environment while storing the pipe liner, nor while curing the resin.

A pipe liner with the characteristics described above as well as a method for rehabilitating defective sewer lines is known from U.S. Pat. No. 6,374,862. The inner film can include a polyamide layer as a barrier, as well as an inwardly adjacent protective layer made of polyurethane, polyester, a polyolefin or a thermoplastic styrene copolymer.

U.S. Pat. No. 4,861,654 discloses a polyamide barrier layer in a similar pipe liner. The inner film described therein can be produced in several layers by a coextrusion process.

US 2010/0243154 proposes a three-layered coextruded inner film having layers of different polyurethanes.

If the curing step of the resin is to be activated by UV light, there also exists the need to first protect the textile or fiber layer impregnated with the UV-curable resin with an UV-proof outer film, while the inner film must be UV-permeable in order to activate the curing process. Suitable films are specified in US 2011/0249751.

If the pipe liner, as previously described, is installed in a section of sewer line, then expanded and fixed in place, the inner film can remain inside the pipe, or it can be pulled out after the curing step is complete. The present invention relates, in particular, to a design that provides for the later removal of the inner film. U.S. Pat. No. 5,186,987 discloses a method of this type.

### OBJECTS OF THE INVENTION

It is therefore an object of the present invention to provide an improved pipe liner and method of relining a defective wastewater conduit or sewer pipe.

Another object is the provision of such an improved pipe liner and method of relining a defective wastewater conduit that overcomes the above-given disadvantages, in particular that is of improved construction with particularly easy and reliable handling.

### SUMMARY OF THE INVENTION

A pipe liner has according to the invention a tubular base of a thermoplastic elastomer or ionomer saturated with a curable resin, and a tubular inner film inside the tubular base itself comprised of a core layer of a thermoplastic elastomer or an ionomer and two polyamide outer layers.

Thus the pipe liner according to the invention is characterized by an inner film having at least three layers, namely at least one core layer made of a thermoplastic elastomer sandwiched between two outer polyamide-based layers. The core layer that is made of the thermoplastic elastomer and/or ionomer provides the entire inner film with increased perforation and tear resistance, thus improving handling reliability even at low temperatures. At the same time, the core layer is protected on both sides by polyamide-based outer layers.

The polyamide-based outer layers provide the entire inner film with improved temperature resistance, thereby avoiding, in particular, any damage to the film during curing of the resin. High temperatures can result from the heat of reaction of the activated resin, as well as due to the heat applied for activating the resin in the fiber/filament base.

Spacing apart the outer polyamide layers also improves the barrier effect with regard to the styrene that is usually contained in the curable resin of the base film as a reactive substance. Particularly due to the complementary properties of polyamide on the one hand and the thermoplastic elastomer and/or ionomer on the other hand, improved mechanical properties are achieved. And the one soft, elastic layer between two hard outer layers generates a certain plywood effect.

Due to the fact that polyamide is present in both outer layers, the inner film can also be easily formed into a closed hose by gluing or sealing the edges of the outer layer onto themselves, for example by forming a so-called fin seam. The fin seam thus formed, which initially projects radially outward, is usually folded over and glued flat in the fold-over state. In particular, an overlap of the tubular inner film is possible as well, with the two outer polyamide layers connected to each other. Making the closed hose with an overlapping seam creates the advantage of a very strong seam that is able to withstand, even when expanding, shear forces between the welded-together outer layers. In contrast to a fin seam, the advantageous result is that not three but only two layers of the inner film are superimposed. In comparison to a fin seam, it is thus possible to also avoid undesired hollow spaces.

While the prior art provides for the usual manufacture of the hose with a film-blowing process as a seamless, enclosed hose, the invention envisions the possibility of initially providing a planar inner film formed into a hose by shaping into a tube and welding. While knowledge and control of the hose diameter are necessary for the manufacture of a seamless hose by blow film extrusion, using a flat film simplifies the process considerably. First, with blow film extrusion, the inflation ratio cannot be freely selected due to the orientation of the macromolecules. With a flat film, however, it is possible to make adjustment cuts, if necessary, in order to obtain a hose having a precisely preset diameter by welding edges of the inner film together. Moreover, there exists the possibility of providing a plurality of inner films that are closed to form a hose from one flat film that is cut into a plurality of strips.

Possible connection methods are any of the customary sealing and welding techniques. This includes heat contact welding, pulsed current arc welding, ultrasonic welding, high-frequency welding and laser welding. However, it is also conceivable that the inner film is glued to form a hose, and it is possible to use, for example a hot-melt glue, PUR glue and epoxy-based single- or dual-component adhesives for this purpose. Heat-contact welding is preferred because it involves a simple process and minimal investment.

The outer layers usually have a thickness between 10 μm and 100 μm, preferably between 20 μm and 80 μm, although the two outer layers can also be of different thicknesses. A suitable material for the outer layers of the inner film is, in particular, a copolyamide, particularly copolyamide PA6/66. The outer layers can be completely made of polyamide, including copolyamide, or they can at least have polyamide as a main component. However, the usual admixtures and blends with other polymers are not excluded.

Polyamide is characterized by a relatively high melting temperature, which is usually above 170° C. The melting temperature T_{M} is determined according to ISO standard 11357-3.

The core layer typically has a thickness of between 10 μm and 200 μm, preferably of between 20 and 80 μm. Especially suited are ionomers or thermoplastic elastomers from the group of elastic polyolefins and elastic polyurethanes. These materials can also be present in a mixture with other polymers to allow for the possibility of controlling further characteristics, for example water vapor permeation.

Ionomers are thermoplastic copolymers made of ethylene and acrylic acid, where sodium or zinc ions neutralize the carboxyl groups forming ion bonds between the molecules. In contrast to conventional plastics, in ionomers ionic bonding forces are active in addition to the secondary valence forces, meaning electrostatic forces between the chains of molecules. Similarly to these elastomers, ionomers also provide a high level of perforation and tear resistance. Moreover, ionomers as well as elastic polyolefins have a good barrier effect relative to water vapor. This is especially advantageous when the pipe liner is supposed to be expanded by steam because, in that case, the resin-impregnated textile or fiber layer is protected against the water vapor and/or moisture. Alternately suited elastic polyurethanes, on the other hand, only provide a low barrier effect with respect to water vapor and are, therefore, preferably used when another type of expansion is implemented, for example by compressed air.

As explained above, a flat film from which a closed hose is formed after the fact can be produced in different ways to obtain the tubular inner film. A flat film can basically also be generated by providing a blown film hose that is directly placed onto itself, where a tacky or not completely cured inner layer of the blow film hose sticks to itself. For example, correspondingly, from a blocked three-layered film of a thickness of 150 μm, it is possible to generate a five-layer film of double the thickness. Using simple means, it is thus possible to manufacture a film by a blow film process having a thickness of, for example, 300 μm.

Using an ionomer or a thermoplastic elastomer, in contrast to known configurations, it is possible to further considerably improve the elasticity and/or stretchiness of the total inner-film tube. This creates the advantage that the entire pipe liner can also be utilized with a greater expansion ratio. This way, it is possible to reduce the number of different diameters of unexpanded pipe liners in terms of the different final diameters of the expanded pipe liner. Since this provides for the possibility of having fewer diameter variants, the costs for manufacturing, warehousing and logistics are reduced when the standard pipe liners that are to be manufactured are, for example, 100 mm to 2000 mm.

The core layer is preferably flexible even at low temperatures when the glass temperature T_{g} of the core layer is advantageously below −20° C., preferably at approximately −50° C. Even if the outer polyamide layers are comparatively rigid at low temperatures, the core layer of the thermoplastic elastomer provides the entire inner film with good mechanical properties even at low ambient temperatures.

It must be taken into account that, when incorporating the pipe liner into a section of sewer pipe, the temperature of this section of sewer pipe will be determined by the ambient temperature. With a core layer having a high level of cold flexibility, it is possible to preclude any tearing or bursting of the inner film even at low external temperatures. Thus, there results the advantage that, according to the present invention, the ambient temperature is for the most part not important, which is why the pipe internal coating material allows for unlimited use under any conditions, particularly also in emergency situations that may arise.

The inner film can have a symmetrically layered construction, such that the arrangement of the inner film within the tubular textile or fiber layer does not require careful alignment or inspection, that is it can be inserted without having to orient one portion of it upward or downward. This way, any incorrect application of the inner film is precluded.

According to the invention, the inner film has at least three layers. As a result, it is possible to add further intermediate layers, for example for improving bonding. For example, if a bond-promoting layer is to be provided between the core layer and each of the two outer layers, there results a five-layered construction that can be formed in particular, by coextrusion. Other methods for producing the inner film, such as by laminating, are not excluded from the scope of the present invention.

The pipe liner includes, in addition to the inner film, preferably an outer film surrounding the tubular textile or fiber layer. The outer film shields the textile or fiber layer during insertion into a sewer pipe to be relined. To the extent that the textile or fiber layer is impregnated and curable with UV light, first UV protection must be ensured even during storage and transport of the prepared pipe liner. Such UV protection can be integrated in the outer film or provided by a separate, outer film. However, the inner film must be permeable to UV light in an embodiment where UV is used to activate the resin. The materials that are preferred in the context of the present invention are characterized by high transmission values in the UV range.

Aside from curing by UV light, it is possible to heat-cure the resin by heat that is supplied, for example, in form of steam or hot water.

In all instances, there results the advantage that, by disposing polyamide in both outer layers of the inner film the heat resistance is increased.

According to a further aspect of the present invention, it is possible to separate the inner film from the textile or fiber layer after the resin has been cured to be able to remove the film after curing is complete. The inner film is detached at one end of the sewer pipe to be relined and pulled off through the sewer pipe that has been relined. Due to the configuration that provides for polyamide on both outer sides of the inner film, it is possible to set adequate release properties relative to the textile or fiber layer by providing weak bond between the inner film and the fiber/filament base film. Even if the inner film is separated after the fact, there results the advantage that it is especially movable while still providing stability, due to the layered construction provided by the invention. The tearing risk of the inner film while pulling it off can thus be considerably reduced.

The tubular textile or fiber layer can be, in particular, a laid web or a woven fabric. Moreover, fiber layers, for example nonwovens, are also suitable for use. Finally, it is also possible to use a plurality of same or different types or layers in combination in order to set a sufficient strength in the textile or fiber layer along with the desired mechanical properties. The textile or fiber layer is preferably made of glass fibers, although natural fibers, plastic fibers, carbon fibers or fiber blends can also be used.

The method has according to the invention the steps of sequentially providing a pipe liner having a tubular base of a thermoplastic elastomer or ionomer saturated with a curable resin, and a tubular inner film inside the tubular base and comprised of a core layer of a thermoplastic elastomer or an ionomer and two polyamide outer layers, inserting the pipe liner into the pipe to be lined, radially outwardly expanding the liner into engagement with an inner surface of the pipe to be lined by means of a fluid, curing and hardening the resin in the tubular base, and stripping the inner film off the liner while leaving the cured base in place against the inner surface of the pipe to be lined.

The pipe liner is introduced into the section of sewer pipe as a strand that initially does not fill the entire of the cross-section of the pipe being lined. The pipe liner can be provided as a longitudinally folded hose. Furthermore, when expanded, meaning when essentially cylindrical, the hose has an external diameter that is smaller than the internal diameter of the section of sewer pipe. The pipe liner is then always stretched to a certain degree before it engages the inner surface of the section of sewer pipe in full surface contact. This step ensures that the pipe liner is fitted evenly and, particularly, without creases, when it is applied with pressure by the fluid. The described composition is also especially advantageous with regard to such an expansion of the pipe liner.

The build-up of pressure is necessary in order to be able to expand the pipe liner by means of the fluid. To this end, following fitting of the pipe liner into the sewer pipe to be relined, both ends are closed and the fluid is applied to its interior. Moreover, it is also conceivable for the inner film to project at one of the pipe liner beyond the tubular textile or fiber layer and be closed off there.

### BRIEF DESCRIPTION OF THE DRAWING

The above and other objects, features, and advantages will become more readily apparent from the following description, reference being made to the accompanying drawing in which:

FIG. 1 is a small scale end view of the liner according to the invention;

FIG. 1a is a large-scale view of the detail indicated at Ia in FIG. 1;

FIG. 2 is a large-scale section through a detail of an inner film of the pipe liner;

FIG. 3 is a cross section through a sewer pipe that has the pipe liner fitted to it;

FIG. 3a is a large-scale view of the detail indicated at IIIa in FIG. 3;

FIG. 4 is a view like FIG. 3 of the fully installed liner; and

FIG. 4a is a large scale vie of the detail indicated at IV a in FIG. 4.

### SPECIFIC DESCRIPTION OF THE INVENTION

As seen in FIG. 1 a pipe liner 9 has a tubular textile or fiber base 1 impregnated with a resin, and an inner film 2 that is coaxially within the tubular textile or fiber base 1. Prior to curing of the resin, the pipe liner 9 is flexible. The curable resin contains styrene as a reactive substance, which is why the inner film 2 and an outer film 3 that wraps around the textile or fiber base 1 have a barrier effect against styrene.

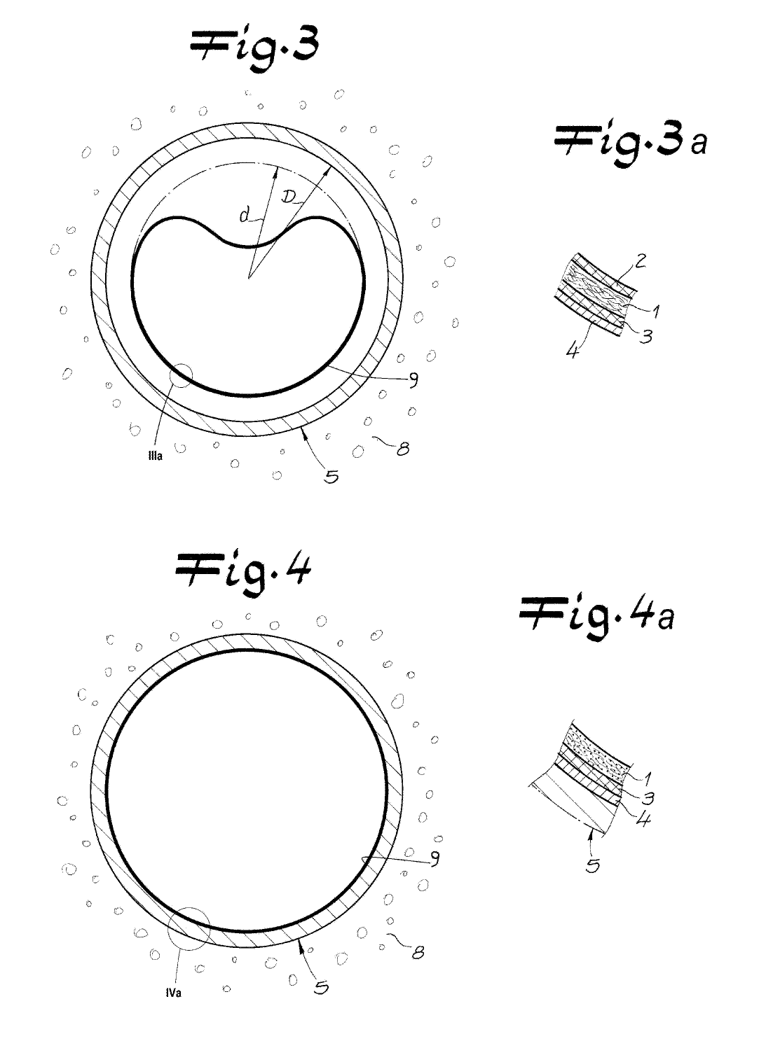

Finally, an additional protective film 4 is provided on the outer surface of the outer film 3, that is on the outer side of the liner 9, shielding the tubular base 1 from UV rays and damage during installation into a section 5 of sewer pipe (see details below regarding FIG. 3).

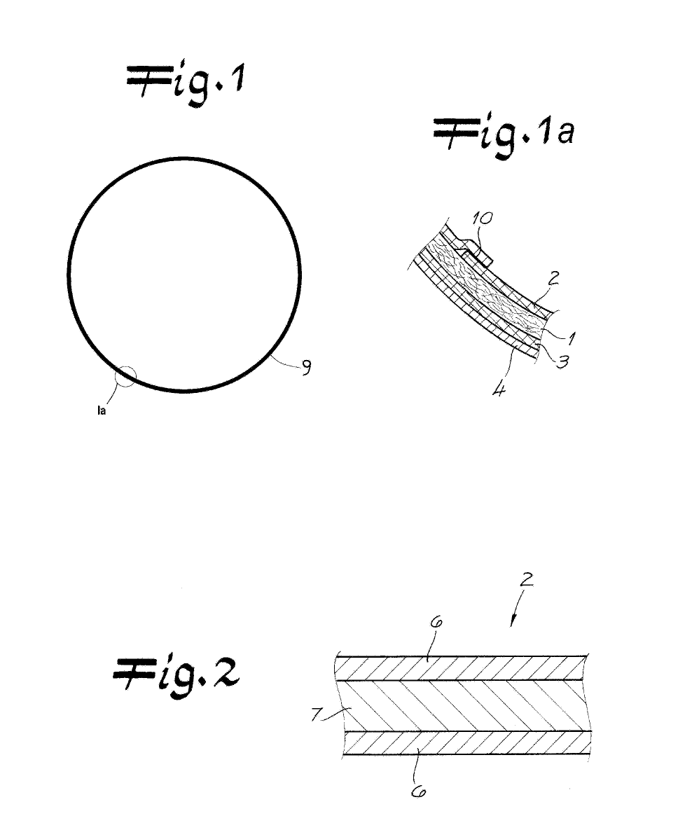

FIG. 2 shows the construction of the layer of the internal film 2 according to the invention. The inner film 2 has three layers, namely two exterior polyamide layers 6 and a core layer 7 of a thermoplastic elastomer. A polyamide copolymer PA6/66 having a melting point above 180° C. is provided for the layers 6. The core layer 7, on the other hand, is made of a thermoplastic elastomer from the group of elastic polyolefins and elastic polyurethanes, where, however, these materials can also be mixed or blended with other plastics as additives.

Both outer layers 6 are formed of a polyamide so they can be formed from flat strips that are thermally welded unitarily into the required tubular shape so that the tubular inner film 2 can be made as a flat film with overlapping edges. FIG. 1 correspondingly shows an overlapping seam 10 where the edges of the inner film 6 are welded together.

The thermoplastic elastomer has a low glass temperature T_{g} below −20° C., and preferably below −50° C. Even at low temperatures, the multiple-layer internal film 2, which is preferably formed by coextrusion, thus remains flexible and able to withstand stress. The pipe liner 9 can thus be used at low temperatures without the inner film 2 bursting or tearing.

In terms of the construction, the inner film 2 according to the invention is basically characterized by its excellent mechanical properties, in that the two cover layers of copolyamide PA6/66 constitute a barrier for the styrene contained in the resin of the textile or fiber base 1.

The outer film 3 is usually also provided with barrier properties with respect to styrene and preferably also has a high level of cold flexibility. Basically, it is conceivable to manufacture the outer film 3 of the same material as the inner film 2. This is particularly possible when an additional is protective film 4 is provided. Moreover, the properties of the protective film 4, such as for example UV protection, can also be integrated into the outer film 3 by choosing a suitable composition for suitable design of the layer.

According to the described embodiment, the UV-activatable resin of the tubular base 1 is curable by UV light, which makes the UV light shield provided by the protective film 4 compulsory. Furthermore, other configurations are possible where curing of the resin is triggered by heat.

The inner film 2, when used in a system with a resin curable by UV light, is exposed to considerable thermal stresses due to the heat of the reaction and otherwise also due to the additional heat input for activating the curing process. According to the invention, the two exterior layers 6 of the inner film 2 have a high level of heat resistance so that during the curing action even a partial or complete melting of the core layer 7 can be accommodated, as long as the outer layers 6 of the inner film 2 remain intact. By the use of polyamide in both outer layers 6 of the inner film 2, it can be easily formed into a closed hose. In particular, hot-sealing of the two outer layers 6 with each other or onto themselves is possible.

In the context of the invention, the inner film 2 can have a symmetrically layered construction. The invention is also not limited to the three-layered configuration as set forth in FIG. 2. In particular, it is possible to provide adhesion-promoting layers or further functional layers between the outer layers 6 and the core layer 7 of the inner film 2.

Depending on the application, the total thickness of the inner film is preferably in the range between 40 and 240 μm. The thickness of the outer layers 6 is preferably between 10 and 80 μm, while the core layer 7 preferably has a thickness between 20 and 80 μm.

FIG. 3 shows a cross-section of a sewer pipe 5 that is to be relined. First the pipe liner according to FIG. 1 is inserted into the sewer pipe 5 with a small longitudinal fold to reduce its diameter. FIG. 3 further indicates that the pipe liner 9 has even when partially inflated to cylindrical shape an outside diameter d that is less than the inside diameter D of the sewer pipe 5.

After the pipe liner 9 has been inserted over the desired length into the sewer pipe 5, it is filled or inflated by a fluid so that it is radially elastically expanded and pressed against the inner surface of the section of sewer pipe 5. If steam is provided as the expansion fluid, the core layer 7 of the inner film 2 is preferably made of an ionomer or an elastic polyolefin, as these materials have a good barrier effect with regard to water vapor.

Following the expansion, the resin with which the textile or fiber base 1 is impregnated, is cured. It is possible to provide, for example, UV light or a heat input for this purpose, depending on the configuration of the resin.

Finally, after the resin has been cured, the inner film 2 is stripped from the textile or fiber base 1 such that the completed liner as shown in FIGS. 4 and 4a results. FIG. 4 shows a relined sewer pipe 5, where places with leaks have been covered up by the pipe liner according to the invention, and where any sewer water is prevented from escaping from the sewer pipe 5 into the surrounding soil 8.

For an examination of the improved properties of the pipe liners, two inner films 2 having a total thickness of 120 μm were manufactured in the context of orientation studies and compared to the a film V according to the prior art. The films E1 and E2 according to the invention have a symmetrical layered construction with outer layers 6 that are each formed of copolyamide PA6/66 of a thickness of 30 μm. The core layer 7 of the film E1 is formed of an elastic polyurethane of a thickness of 60 μm, while the core layer 7 of film E2 of the same thickness is made of a Zn ionomer (zinc ionomer) as a thermoplastic plastic material.

The films E1 and E2 according to the invention are compared, as shown below in the table, with a film comprising only two layers made of polyethylene (PE) and polyamide (PA), also of a total thickness of 120 μm.

The ultimate tensile strength of the films is determined according to DIN ISO 527-1 with a type 2 test specimen, wherein the ultimate tensile strength is indicated for the longitudinal manufacturing direction (MD) and for the crosswise direction (CD) transverse thereto. Puncture resistance was established according to DIN EN 14477 for a temperature of 23° C. and a temperature of −4° C. Finally, the permeability to water vapor was determined according to ASTM F 1249. The permeability to water vapor was established at a temperature of 38° C. and a relative humidity of 90%.

In contrast to the comparison example described below in the table, the two films E1 and E2 according to the invention demonstrate considerably improved ultimate tensile strength and puncture resistance. The core layer made of Zn ionomer (film E2) demonstrates overall a good barrier effect against water vapor, which is why this film can easily be used for expansion of the pipe liner by steam. On the other hand, the barrier effect of film E1 relative to water vapor was minimal, which is why this film is particularly suited for a different expansion type, for example by hot air.

| | | | | | Water Vapor |
|---|---|---|---|---|---|
| | Ultimate Tensile | | Puncture Resistance | | Permeability |
| | Strength | | T = 23° | T = −4° | T = 38° C./ |
| Film | MD | CD | C. | C. | RH = 90% |
| Type | [N/mm2] | [N/mm2] | [N] | [N] | [g/d/m²] |
| E1 | 76 | 77 | 15 | 18 | 65 |
| E2 | 73 | 60 | 12 | 13 | 6 |
| V | 44 | 40 | 6 | 7 | 4 |

We claim:

1. A pipe liner comprising:
a tubular base of a thermoplastic elastomer or ionomer saturated with a curable resin; and
a tubular inner film inside the tubular base and comprised of a core layer of a thermoplastic elastomer or an ionomer and two polyamide outer layers.

2. The pipe liner defined in claim 1, wherein the outer layer is a copolyamide.

3. The pipe liner defined in claim 2, wherein the copolyamide is PA6/66.

4. The pipe liner defined in claim 1, wherein the core layer has a radial thickness of 10 μm to 80 μm.

5. The pipe liner defined in claim 1, wherein the core layer has a radial thickness of 20 μm to 80 μm.

6. The pipe liner defined in claim 1, wherein the core layer has a glass temperature below −20° C.

7. The pipe liner defined in claim 1, wherein the core layer is an elastic polyolefin or an elastic polyurethane.

8. The pipe liner defined in claim 1, wherein the core layer is a Zn-ionomer.

9. The pipe liner defined in claim 1, wherein the tubular inner film is of axially symmetrical construction.

10. The pipe liner defined in claim 1, further comprising:
a tubular outer film outside the tubular base.

11. The pipe liner defined in claim 1, wherein the inner and core layers are coextruded.

12. A method of lining a pipe, the method comprising the steps of sequentially:
providing a pipe liner having
a tubular base of a thermoplastic elastomer or ionomer saturated with a curable resin; and
a tubular inner film inside the tubular base and comprised of a core layer of a thermoplastic elastomer or an ionomer and two polyamide outer layers;
inserting the pipe liner into the pipe to be lined;
radially outwardly expanding the liner into engagement with an inner surface of the pipe to be lined by means of a fluid;
curing and hardening the resin in the tubular base; and
stripping the inner film off the liner while leaving the cured base in place against the inner surface of the pipe to be lined.
